(19) United States
(12) Patent Application Publication
(10) Pub. No.: US 2019/0028215 A1
(43) Pub. Date: Jan. 24, 2019

(54) RADIO ENVIRONMENT ESTIMATION DEVICE, RADIO ENVIRONMENT ESTIMATION SYSTEM, RADIO ENVIRONMENT ESTIMATION METHOD, AND RECORDING MEDIUM

(71) Applicant: NEC CORPORATION, Tokyo (JP)

(72) Inventor: Masaki KITSUNEZUKA, Tokyo (JP)

(73) Assignee: NEC CORPORATION, Tokyo (JP)

(21) Appl. No.: 16/070,334

(22) PCT Filed: Jan. 23, 2017
(86) PCT No.: PCT/JP2017/002052

§ 371 Date: Jul. 16, 2018

(30) Foreign Application Priority Data
Jan. 25, 2016 (JP) 2016-011695

(51) Int. Cl. H04B 17/336; H04B 7/06

(52) U.S. Cl. CPC H04B 17/336; H04B 7/0634; H04B 7/0695

(57) ABSTRACT

In order to quickly perform estimation processing while suppressing a deterioration in estimation accuracy caused by the impact of an obstacle present in the vicinity of a sensor, an impact-level assessment unit assesses the level of the impact imparted on an observable at another location by an observable detected by a sensor for detecting observables, which represent the features of an electrical signal obtained by receiving a radio wave. In addition, a weighting factor calculation unit calculates a sensor weighting factor on the basis of the position of the estimation location at which the observable is to be estimated, the position of the sensor, and the assessed impact level from the impact-level assessment unit. Furthermore, a weighted averaging unit estimates the observable at the estimation location by calculating a weighted average of the observable detected by the sensor, by using the sensor weighting factor calculated by the weighting factor calculation unit.

### TECHNICAL FIELD

The present invention relates to a radio environment estimation device, a radio environment estimation system, a radio environment estimation method, and a recording medium.

### BACKGROUND ART

Construction of radio environment databases by sensing the radio waves has been proposed, for the purpose of early finding of radio wave interferences and sharing of the radio wave resources (NPL 1). Since there is a limit on the number of sensors that can be provided, it is necessary to estimate the radio environment at the location in which no sensor is provided (i.e., non-observed location) based on a radio environment obtained by a sensor.

When estimating the radio environment at a non-observed location using a radio environment obtained by a sensor, there may be a large estimation error in radio environment at the non-observed location due to the impact of an obstacle, even though the sensor operates normally, depending on the location at which the sensor is provided. For example, suppose a case in which a first sensor can look out over a radio wave transmitting station, and a second sensor is provided in the vicinity of the first sensor but cannot look out over the transmitting station due to an obstacle. In this case, the radio environments of these two sensors are largely different from each other. Therefore, when estimating the observation amount of the radio environment at a non-observation location which is nearer to the transmitting station than to the obstacle, by using the observation data obtained from these two sensors, the estimation error is feared to be large.

Kriging method and inverse distance weighting (IDW method) are examples of methods to estimate the observation amount at the estimation location by interpolating the observation amounts at a plurality of observation locations.

Kriging method estimates the observation amount at the estimation location, by creating a model of the correlation level of the relative distance to the observation location, and using the weight in accordance with the model thereby obtaining the weighted average of the observation amounts. In other words, Kriging method is a method to create a model using data at a multitude of observation locations. Therefore, even when the observation amount of a sensor is largely deviated from the actual value of the estimation location due to the impact of an obstacle, Kriging method can decrease the impact on the final estimation impact. Note that PTL 1 discloses a technique of enhancing the accuracy of interpolation by complementing processing at a confidence level that is unrelated to the location of the sensor.

IDW method is to estimate the observation amount at the estimation location by obtaining the weighted average of the observation amounts by setting, as a weight, the inverse of the distance between the estimation location and each observation location. IDW method is an interpolation method using a simple weighting coefficient, solely based on data at the near-by observation location. Therefore, by using IDW method, the radio environment will be estimated with less calculation amount, and more quickly.

### CITATION LIST

### Patent Literature

[PTL 1] Japanese Patent Application Publication No. 2015-10927

### Non Patent Literature

[NPL 1] Koya Sato, Masayuki Kitamura, Kei Inage, and Takeo Fujii, “Measurement-based spectrum database for flexible spectrum management,” IEICE Trans. Commun., vol. E98-B, no. 10, pp. 2004-2013, October 2015.

### SUMMARY OF INVENTION

### Technical Problem

However, when Kriging method is used to estimate an observation amount, the estimation processing takes time, and estimation at a temporary short interval may become difficult. This is because, when using Kriging method to estimate an observation amount, it is necessary to generate a correlation model using a multitude of observation data.

When IDW method is used to estimate an observation amount, the estimation accuracy may change, depending on geographical conditions such as that an obstacle exists between an observation location and an estimation location. This is because IDW method estimates solely based on the distance between an observation location and an estimation location.

In addition, the confidence level that does not have correlation with the location of a sensor used in the method described in PTL 1 cannot decrease the error caused due to geographical situations surrounding an observation location and an estimation location, such as due to the impact of an obstacle.

An object of the present invention is to provide a radio environment estimation device, a radio environment estimation system, a radio environment estimation method, and a program, which can solve the above-stated problems.

### Solution to Problem

According to a first aspect of the present invention, a radio environment estimation device includes: an impact-level assessment unit for assessing an impact level that represents a level of impact that an observation amount representing a feature of an electric signal obtained by receiving a radio wave and that is detected by a sensor for detecting the observation amount has on an observation amount at other locations; a weighting coefficient calculation unit for calculating a weighting coefficient of the sensor, based on a position of an estimation location to be an observation-amount estimation target and a position of the sensor, as well as on the impact level assessed by the impact-level assessment unit; and a weighted averaging unit for estimating an observation amount at the estimation location, by calculating a weighted average of the observation amount detected by the sensor, using the weighting coefficient of the sensor having been calculated by the weighting coefficient calculation unit.

According to a second aspect of the present invention, a radio environment estimation system includes: a sensor for detecting an observation amount representing a feature of an electric signal obtained by receiving a radio wave; and the radio environment estimation device according to the above-stated aspect.

According to a third aspect of the present invention, a radio environment estimation method includes: assessing an impact level that represents a level of impact that an observation amount representing a feature of an electric signal obtained by receiving a radio wave and that is detected by a sensor for detecting the observation amount has on an observation amount at other locations; calculating a weighting coefficient of the sensor, based on a position of an estimation location to be an observation-amount estimation target and a position of the sensor, as well as on the assessed impact level; and estimating an observation amount at the estimation location, by calculating a weighted average of the observation amount detected by the sensor, using the weighting coefficient of the sensor having been calculated.

According to a fourth aspect of the present invention, a recording medium stores therein a program to make a computer to execute: assessing an impact level that represents a level of impact that an observation amount representing a feature of an electric signal obtained by receiving a radio wave and that is detected by a sensor for detecting the observation amount has on an observation amount at other locations; calculating a weighting coefficient of the sensor, based on a position of an estimation location to be an observation-amount estimation target and a position of the sensor, as well as on the assessed impact level; and estimating an observation amount at the estimation location, by calculating a weighted average of the observation amount detected by the sensor, using the weighting coefficient of the sensor having been calculated.

### Advantageous Effect of Invention

According to at least one of the aspects described above, a radio environment estimation device can perform estimation processing quickly, while retraining the deterioration in estimation accuracy due to an obstacle existing near the sensor.

### BRIEF DESCRIPTION OF DRAWINGS

FIG. 1 illustrates an exemplary apparatus arrangement in a radio environment estimation system according to a first example embodiment.

FIG. 2 illustrates a configuration of a radio environment estimation device according to the first example embodiment.

FIG. 3 illustrates an exemplary configuration of a sensor according to the first example embodiment.

FIG. 4 illustrates a first exemplary configuration of an impact-level assessment unit according to the first example embodiment.

FIG. 5 illustrates a second exemplary configuration of the impact-level assessment unit according to the first example embodiment.

FIG. 6 illustrates a first exemplary configuration of a weighting coefficient calculation unit according to the first example embodiment.

FIG. 7 illustrates a second exemplary configuration of the weighting coefficient calculation unit according to the first example embodiment.

FIG. 8 is a flowchart illustrating an operation in the first example embodiment.

FIG. 9 is a flowchart illustrating prior assessment processing according to the first example embodiment.

FIG. 10 is a flowchart illustrating data analysis processing according to the first example embodiment.

FIG. 11 illustrates an exemplary apparatus arrangement in a radio environment estimation system according to a second example embodiment.

FIG. 12 illustrates a configuration of a radio environment estimation device according to the second example embodiment.

FIG. 13 illustrates a first exemplary configuration of an arrayed sensor according to the second example embodiment.

FIG. 14 illustrates a second exemplary configuration of the arrayed sensor according to the second example embodiment.

FIG. 15 is a flowchart illustrating prior assessment processing according to the second example embodiment.

FIG. 16 illustrates an exemplary apparatus arrangement in a radio environment estimation system according to a third example embodiment.

FIG. 17 illustrates a configuration of a radio environment estimation device according to the third example embodiment.

FIG. 18 illustrates an exemplary configuration of a wide-band sensor according to the third example embodiment.

FIG. 19 is a flowchart illustrating prior assessment processing according to the third example embodiment.

FIG. 20 illustrates a basic configuration of a radio environment estimation device.

### EXAMPLE EMBODIMENT

The following explains some example embodiments with reference to the drawings.

### First Example Embodiment

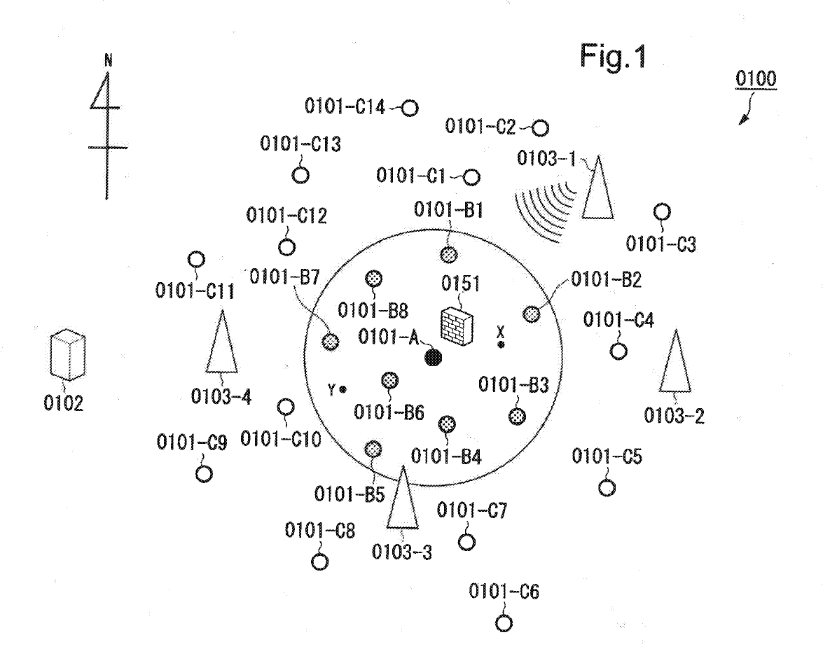

FIG. 1 illustrates an exemplary apparatus arrangement in a radio environment estimation system according to a first example embodiment.

A radio environment estimation system 0100 according to the first example embodiment analyzes a radio environment in an observation area, which is a radio environment observation target. The radio environment estimation system 0100 includes a plurality of sensors 0101 and a radio environment estimation device 0102. The sensors 0101 are provided in observation locations in the observation area, and detect an observation amount of the radio environment, in the respective observation locations. The radio environment estimation device 0102 collects the observation amounts detected by the sensors 0101, and estimates the radio environment of the observation area. The sensors 0101 and the radio environment estimation device 0102 are connected to each other via a network such as the Internet. Note that in the observation area and in the vicinity of the observation area, a radio base station 0103, which emits radio waves, is provided.

### Explanation of Configuration

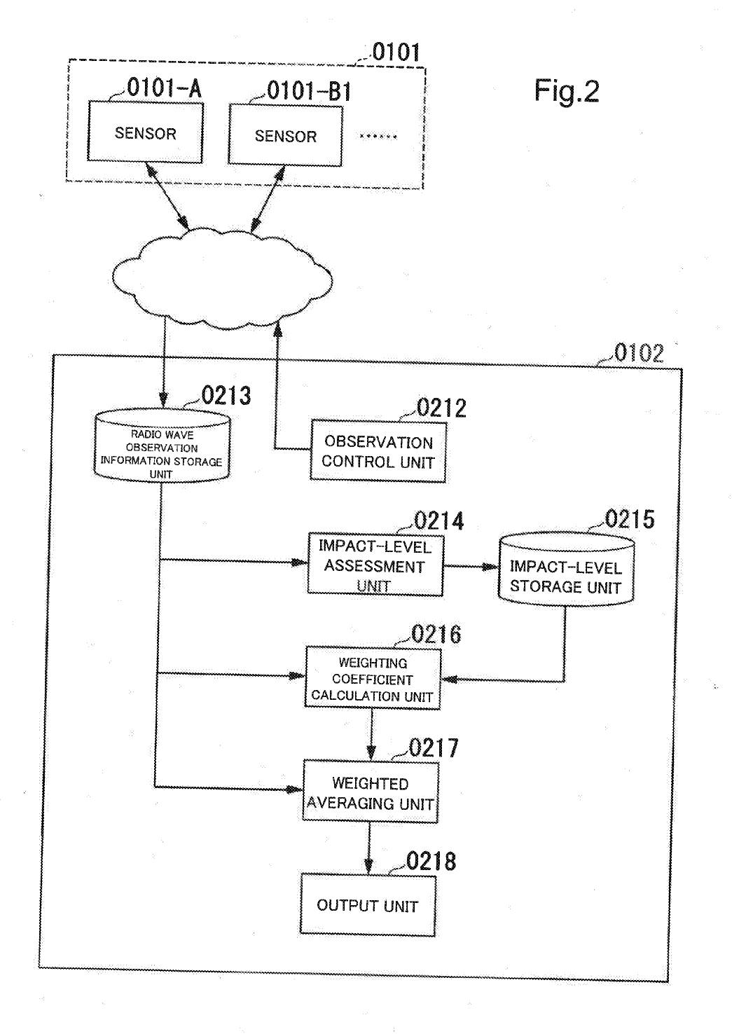

FIG. 2 illustrates a configuration of a radio environment estimation device according to the first example embodiment.

The radio environment estimation device 0102 according to the first example embodiment includes an observation control unit 0212, a radio wave observation information storage unit 0213, an impact-level assessment unit 0214, an impact-level storage unit 0215, a weighting coefficient calculation unit 0216, a weighted averaging unit 0217, and an output unit 0218.

The observation control unit 0212 controls each sensor 0101.

The radio wave observation information storage unit 0213 obtains the observation amount observed by each sensor 0101 via the network, and stores it therein. The impact-level assessment unit 0214 assesses, for each sensor 0101, an impact level representing a level of impact of the observation amount detected by that sensor 0101 on an observation amount in the other locations, based on the observation amount stored in the radio wave observation information storage unit 0213. Note that the assessment level is a value that is not dependent on a distance between an observation location in which the sensor 0101 is provided and an estimation location. The impact-level storage unit 0215 stores an impact level of each sensor 0101 having been estimated by the impact-level assessment unit 0214. The weighting coefficient calculation unit 0216 calculates a weighting coefficient of each sensor 0101, based on the impact level stored in the impact-level storage unit 0215. The weighting coefficient calculated by the weighting coefficient calculation unit 0216 is smaller in value as a distance between the estimation location and the observation location is longer, and is larger in value as the impact level is larger. The weighted averaging unit 0217 calculates a weighted average of an observation amount, based on the observation amount stored in the radio wave observation information storage unit 0213 and the weighting coefficient calculated by the weighting coefficient calculation unit 0216. The result of calculation of the weighted average by the weighted averaging unit 0217 represents an observation amount at the estimation location. The output unit 0218 outputs the calculation result of the weighted averaging unit 0217.

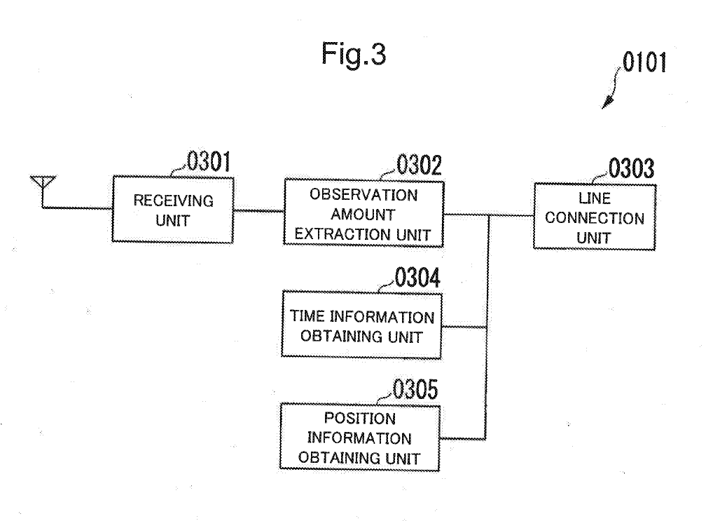

FIG. 3 illustrates an exemplary configuration of a sensor according to the first example embodiment.

A sensor 0101 according to the first example embodiment includes a receiving unit 0301, an observation amount extraction unit 0302, a time information obtaining unit 0304, a position information obtaining unit 0305, and a line connection unit 0303.

The receiving unit 0301 receives radio wave, and converts the radio wave into an electric signal.

The observation amount extraction unit 0302 extracts an observation amount from the electric signal converted by the receiving unit 0301.

Specific examples of the observation amount are a pair of frequency of received radio wave and an average value of a received electric power, a received bandwidth, and a peak value of the received electric power. In addition, not only an observation amount made up of the average value which is a first-order statistical moment of the received electric power, but also an observation amount made up of its dispersion being a second-order moment, a distortion level related to a third-order moment, and a kurtosis related to a fourth-order moment may be used as an observation amount. Also as an observation amount, a statistical moment for the time-differentiated amount of the momentary received electric power may be used. Also as an observation amount, other statistical amounts such as cumulant may be used. Furthermore, as an observation amount, a voltage amplitude of a received signal, probability density distribution function of an electric power, its cumulative distribution function, a complementary cumulative distribution function, or other distributions may be used. In addition, it is also possible to use a combination of two or more of the above-explained examples of observation amount, as an observation amount.

The time information obtaining unit 0304 obtains a current time. The time information obtaining unit 0304 provides a function necessary to observe at a time designated by the observation control unit 0212. For example, the time information obtaining unit 0304 may obtain time information by connecting to a network time protocol (NTP) server via the Internet. In addition, the time information obtaining unit 0304 may obtain the time by amending the time information indicated by a navigation satellite system (NSS) signal. Note that, in other example embodiments, when the observation control unit 0212 transmits a start signal to the sensor 0101 at the time of observation start, and each sensor 0101 starts observing upon receiving the start signal, the sensor 0101 does not always have to include a time information obtaining unit 0304. However, in that case, a time lag may occur in conveyance of transmission and reception of a signal, thereby causing a difference in timing of observation start in each sensor 0101.

The position information obtaining unit 0305 obtains information on the observation location in which the sensor 0101 is provided.

The position information obtaining unit 0305 provides a function necessary to associate an observed observation amount to the position at which the observation amount is obtained. For example, the position information obtaining unit 0305 may obtain positional information by means of NSS. The position information obtaining unit 0305 may store the positional information at the time of provision of the sensor 0101, and read the positional information when necessary. Note that, in other example embodiments, when the radio wave observation information storage unit 0213 includes a database in which the identifiers (ID) of the sensors 0101 are associated with positional information, the sensor 0101 does not always have to include a position information obtaining unit 0305.

The line connection unit 0303 transmits, to the radio environment estimation device 0102, an observation amount, the time, and an observation location, via a network line.

The following explains, as exemplary configurations of the impact-level assessment unit 0214, a first exemplary configuration and a second exemplary configuration.

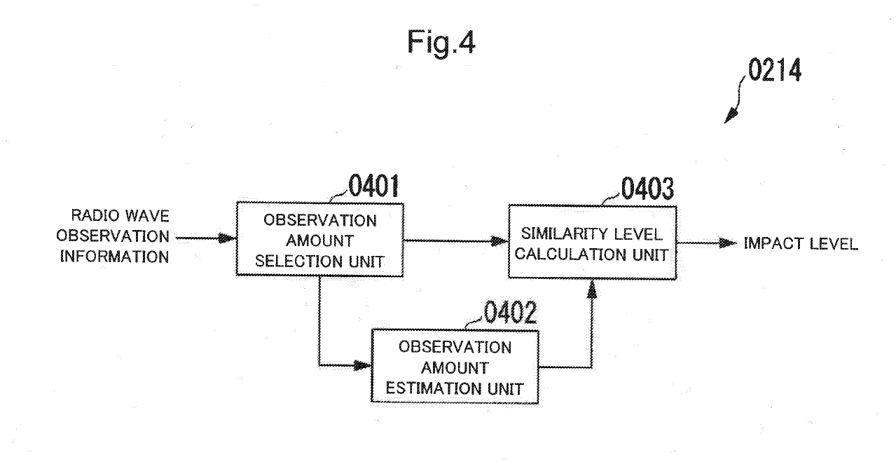

FIG. 4 illustrates a first exemplary configuration of an impact-level assessment unit according to the first example embodiment.

An impact-level assessment unit 0214 in the first exemplary configuration includes an observation amount selection unit 0401, an observation amount estimation unit 0402, and a similarity level calculation unit 0403.

The observation amount selection unit 0401 selects a target sensor which is to be an impact-level assessment target, from among the sensors 0101. The observation amount selection unit 0401 obtains an observation amount of the selected target sensor and an observation amount of the other sensors.

The observation amount estimation unit 0402 estimates the observation amount detected by the target sensor, based on the observation amount of the other sensors. A preferable method to estimate the observation amount of the target sensor, based on the observation amount of the other sensors would be a method by which the estimation error does not deteriorate much even when the data of the other sensors include an error. Specifically, the observation amount estimation unit 0402 may use Kriging method, instead of IDW method, in estimating the observation amount detected by the target sensor. The similarity level calculation unit 0403 calculates a similarity level between the observation amount by the target sensor and the observation amount estimated by the observation amount estimation unit 0402.

Note that the impact-level assessment unit 0214 does not have to assess the impact level frequently; it may assess the impact level at least once in system start-up. Thus, even when the impact-level assessment unit 0214 uses Kriging method in calculating the impact level, there will be no impact on the calculation amount in estimation of the observation amount at the estimation location performed by the weighted averaging unit 0217.

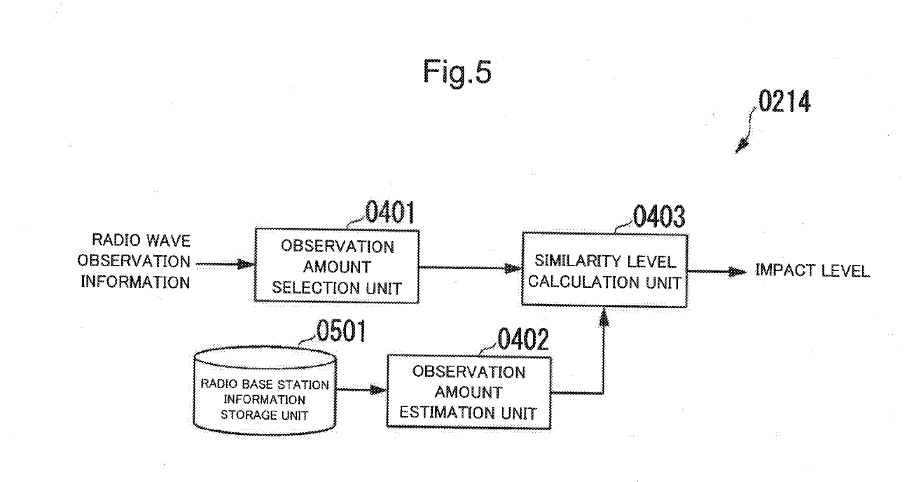

FIG. 5 illustrates a second exemplary configuration of the impact-level assessment unit according to the first example embodiment.

The impact-level assessment unit 0214 according to the second exemplary configuration further includes a radio base station information storage unit 0501, in addition to the impact-level assessment unit 0214 according to the first exemplary configuration. The radio base station information storage unit 0501 stores information on the radio base station 0103 transmitting the radio wave received by the target sensor. The observation amount estimation unit 0402 estimates the observation amount of the target sensor, based on the information stored in the radio base station information storage unit 0501. The similarity level calculation unit 0403 calculates a similarity level between the observation amount of the target sensor and the observation amount estimated by the observation amount estimation unit 0402. The observation amount estimation unit 0402 according to the second exemplary configuration may estimate the observation amount of the target sensor, by simulating the radio wave propagation, based on the height of the antenna, the transmission electric power, the frequency, the modulation bandwidth, the modulation method, and the other information of the radio base station 0103, and the geographic information including the geographical characteristics. During this process, it is also possible to assess the impact levels of the sensors 0101, by solely relying on the radio wave propagation simulation by using the geographical model taking into consideration the material and the structure of the buildings, and the height and the density of the forest in addition to the geographical information, without relying on any actual observation.

Specific examples of the similarity level of the observation amount calculated by the similarity level calculation unit 0403 are a Pearson correlation coefficient, a Euclidean distance, and a Manhattan distance. When a Pearson correlation coefficient is used as a similarity level of the observation amount, the trends between the estimated observation amount and the actually obtained observation amount can be taken into consideration. Because the range of the values of a Pearson correlation coefficient is −1 to +1, the similarity level calculation unit 0403 may calculate, as an impact level, the value standardized to fall on the value range of equal to or more than 0. On the other hand, when a Euclidean distance or a Manhattan distance is used as a similarity level of the observation amount, the absolute error between the estimated observation amount and the actually obtained observation amount is treated to be small. Note that the range of the values is equal to or more than 0, for both of a Euclidean distance or a Manhattan distance.

The following explains a first exemplary configuration and a second exemplary configuration, as exemplary configurations of the weighting coefficient calculation unit 0216.

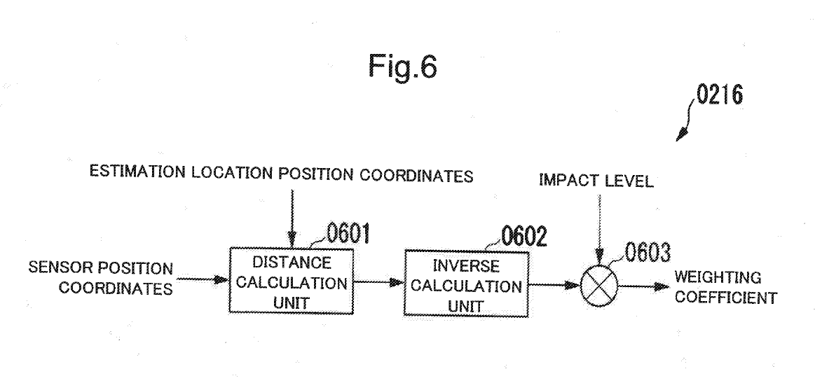

FIG. 6 illustrates the first exemplary configuration of a weighting coefficient calculation unit according to the first example embodiment.

The weighting coefficient calculation unit 0216 according to the first exemplary configuration includes a distance calculation unit 0601, an inverse calculation unit 0602, and an adding unit 0603.

The distance calculation unit 0601 calculates a distance between an estimation location and each observation location, and outputs the result as an array.

The inverse calculation unit 0602 calculates an inverse of each element in the array output by the distance calculation unit 0601, and outputs the result as an array.

The adding unit 0603 outputs an array whose element is the value obtained by calculating the product between each element of the array output by the inverse calculation unit 0602 and the impact level of the corresponding sensor 0101.

Here, it is convenient to have a positive impact level value. In addition, the weighting coefficient calculation unit 0216 does not always have to calculate the weighting coefficients for all the sensors 0101, but may calculate the weighting coefficient only for the observation location in the vicinity of the estimation location. This simplifies the calculation, and therefore, the weighting coefficient calculation unit 0216 can perform processing quickly. Exemplary methods for selecting an observation location in the vicinity of the estimation location are a method to select the observation location that lies within a distance from the estimation location and a method to select the designated number of observation locations from those nearer to the estimation location.

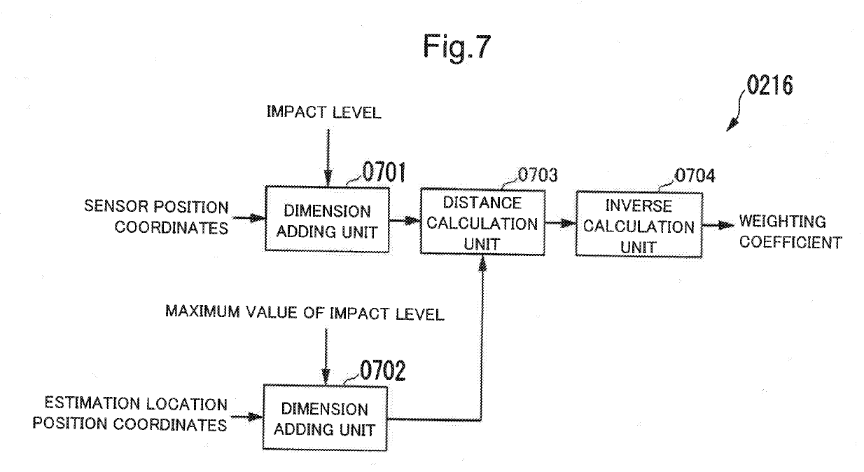

FIG. 7 illustrates a second exemplary configuration of the weighting coefficient calculation unit according to the first example embodiment.

The weighting coefficient calculation unit 0216 according to the second exemplary configuration includes a dimension adding unit 0701, a dimension adding unit 0702, a distance calculation unit 0703, and an inverse calculation unit 0704.

The dimension adding unit 0701 adds a dimension of an impact level to the position coordinates of the estimation location.

The dimension adding unit 0702 adds a dimension of an impact level to the position coordinates of the observation location.

The distance calculation unit 0703 calculates a distance between the estimation location and each observation location incorporating therein the impact level, based on the outputs from the dimension adding unit 0701 and the dimension adding unit 0702, and outputs the result as an array.

The inverse calculation unit 0704 calculates an inverse of each element in the array output by the distance calculation unit 0703, and outputs the result as an array.

Here, the value of the dimension of the impact level to be added to the position coordinates of the observation location by the dimension adding unit 0702 is the impact level of the sensor 0101 provided in the corresponding observation location assessed in advance. The possible range for the impact level can be standardized depending on how much impact the impact level will have on the estimation result. In addition, the value of the dimension of the impact level to be added to the position coordinates of the estimation location by the dimension adding unit 0701 will be set as the maximum possible value which the impact level can take.

By doing so, even when the first sensor having a relatively high impact level and the second sensor having a relatively low impact level are provided to be away at an equal distance from the estimation location, the distance incorporating therein the impact level will be shorter for the first sensor than for the second sensor. As a result, the weighting coefficient of the sensor 0101 having a higher impact level is larger than the weighting coefficient of the sensor 0101 having a lower impact level.

### Explanation of Operation

The following explains an operation of the radio environment estimation system 0100 according to the first example embodiment.

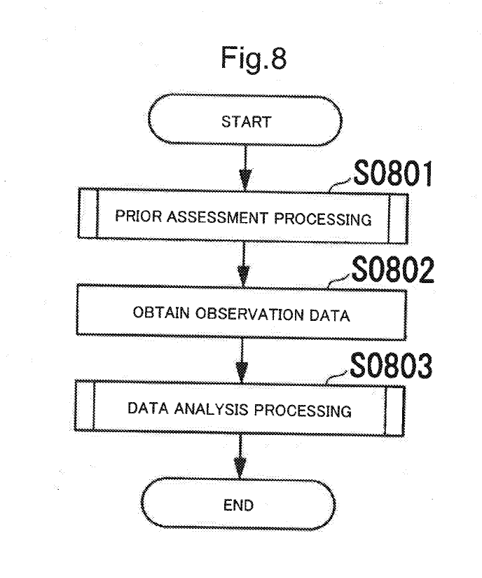

FIG. 8 is a flowchart illustrating an operation in the first example embodiment.

First, the radio environment estimation device 0102 performs prior assessment processing to assess the impact level of each sensor (Step S0801). Next, the observation control unit 0212 outputs an observation instruction to each sensor 0101, and obtains observation data representing an observation amount (Step S0802). The radio wave observation information storage unit 0213 stores the obtained observation data. Then, the radio environment estimation device 0102 performs data analysis processing to analyze the collected observation data (Step S0803).

The following is a detailed explanation of the prior assessment processing in Step S0801 and the data analysis processing in Step S0803.

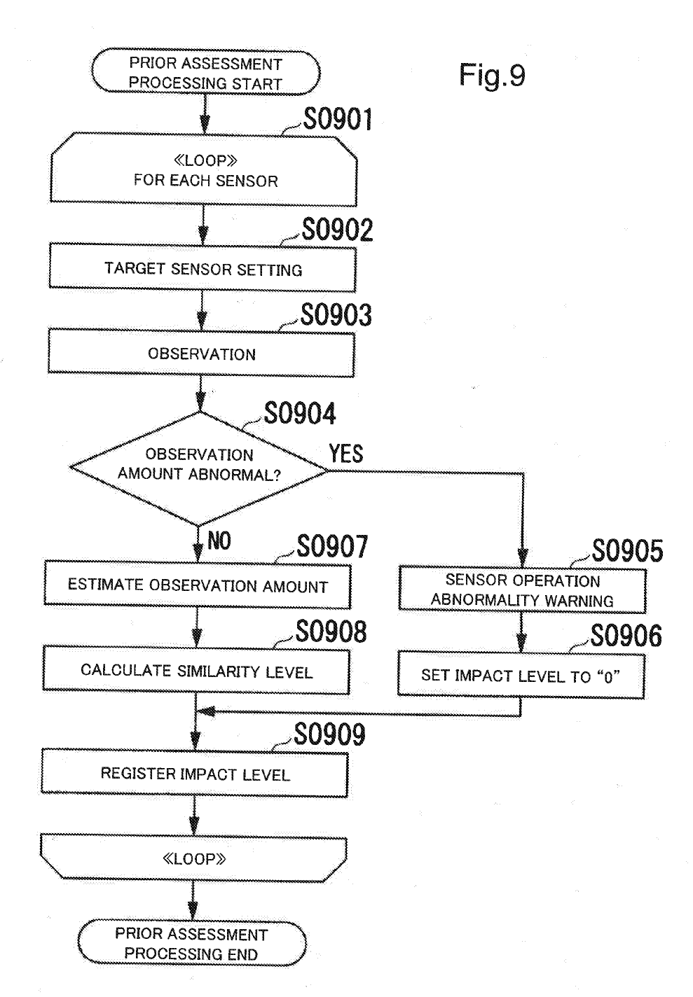

FIG. 9 is a flowchart illustrating prior assessment processing according to the first example embodiment.

When the radio environment estimation device 0102 starts prior assessment processing, the impact-level assessment unit 0214 selects the target sensors to be the impact-level assessment target from among the sensors 0101, one by one, and performs processing from Step S0902 to Step S0909 described below (Step S0901).

Here, the impact-level assessment unit 0214 may select all the sensors 0101 as the target sensors, or may select only a part of the sensors 0101 as the target sensors. For example, the sensors 0101 may be classified into a plurality of groups, in advance. Then, at the initial activation of the radio environment estimation system 0100 according to the first example embodiment, the impact-level assessment unit 0214 may set all the sensors 0101 as the target sensors, and any normal time thereafter, the impact-level assessment unit 0214 may set a group of sensors 0101 to be the target sensor day by days. Note that when there is any incident such as city development, natural disaster, and other phenomena, which is expected to have greatly changed the radio environment, the impact-level assessment unit 0214 sets all the sensors 0101 to be the target sensor.

The impact-level assessment unit 0214 sets, for the target sensors selected in Step S0901, a frequency to be observed, a gain or a bandwidth of receiving means, and the time for observation start (Step S0902). Note that when observing a sensor 0101 in the vicinity of the target sensor (e.g., when using the impact-level assessment unit 0214 according to the first exemplary configuration (FIG. 4)), the similar setting is performed on the other sensors.

Next, the observation control unit 0212 outputs an observation instruction to the target sensor and the other sensors to observe at the set conditions, and obtains an observation amount from the target sensor and the other sensors (Step S0903). Then, the impact-level assessment unit 0214 judges whether the obtained observation amount has any abnormality (Step S0904). Specifically, the impact-level assessment unit 0214 judges whether the observation amount exhibits a value that is outside of a predetermined range. When the obtained observation amount has an abnormality (Step S0904: YES), the impact-level assessment unit 0214 issues a warning to indicate a sensor operation abnormality (Step S0905). In addition, the impact-level assessment unit 0214 sets the impact level of the target sensor to the lowest (e.g., “0”) (Step S0906).

On the other hand, when there is no abnormality in the obtained observation amount(Step S0904: NO), the impact-level assessment unit 0214 estimates the observation amount at the observation location of the target sensor for a reference purpose, without using the observation amount detected by the target sensor (Step S0907). Next, the impact-level assessment unit 0214 calculates a similarity level between the estimated observation amount and the observation amount actually detected by the target sensor (S0908). Then as the impact level of the target sensor, the impact-level assessment unit 0214 records, in the impact-level storage unit 0215, the impact level set in Step S0906 or the similarity level calculated in Step S0908, together with the sensor ID (Step S0909).

By performing the above processing for each sensor, the impact-level storage unit 0215 stores therein the impact level of each sensor 0101.

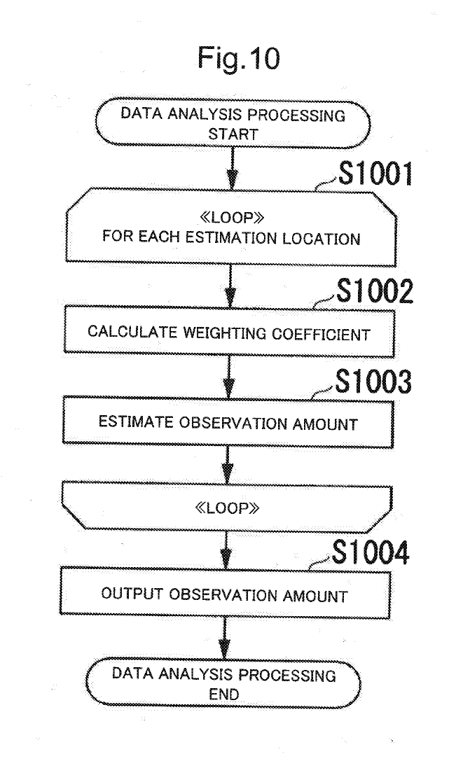

FIG. 10 is a flowchart illustrating data analysis processing according to the first example embodiment.

Upon start of data analysis processing, from among the locations within the observation area for which the radio environment is to be output, the radio environment estimation device 0102 selects, one by one, estimation locations at which no sensor 0101 is provided, and performs the processing from

Step S1002 to Step S1003 explained below (Step S1001).

First, the weighting coefficient calculation unit 0216 calculates the weighting coefficient of each sensor 0101, based on the impact level stored in the impact-level storage unit 0215 in association with the sensor 0101 and on the distance between the observation location for sensor 0101 and the estimation location (Step S1002). Next, the weighted averaging unit 0217 estimates the observation amount at the estimation location, by calculating the weighted average of the observation amount, based on the observation amount stored in the radio wave observation information storage unit 0213 and the weighting coefficient calculated by the weighting coefficient calculation unit 0216 (Step S1003).

When the weighted averaging unit 0217 has estimated the observation amounts for all the estimation locations within the observation area, the output unit 0218 outputs the observation amount estimated by the weighted averaging unit 0217 and the observation amount actually measured by the sensor 0101 (Step S1004).

The following specifically explains the operation in the first example embodiment, under the assumption of the environment illustrated in FIG. 1.

Within the observation area illustrated in FIG. 1, sensors 0101-A, 0101-B1 to 0101-B8, 0101-C1 to 0101-C14, and radio base stations 0103-1 to 0103-4 are located. In addition, between the sensor 0101-A and the radio base station 0103-1, an obstacle 0151 is located, and it is impossible to look out over the radio base station 0103-1 from the sensor 0101-A. In addition, the sensors 0101-B1 to 0101-B8 are located within a predetermined distance from the sensor 0101-A.

Furthermore, the radio environment estimation device 0102 is assumed to include an impact-level assessment unit 0214 according to the first exemplary configuration illustrated in FIG. 4. That is, the impact-level assessment unit 0214 calculates the impact level, based on the observation amount of the target sensor and the observation amounts of the other sensors.

First, after setting the target sensor 0101-A and the other sensors 0101-B1 to 0101-B8 in a prior assessment step, the radio environment estimation device 0102 instructs observation, and obtains an observation amount. The observation amount observed in the target sensor 0101-A greatly differs from the observation amounts observed in the other sensors 0101-B1 to 0101-B8, and the corresponding impact level is assessed to be low. By performing such impact-level assessment to all the sensors, the data on impact levels are accumulated in the impact-level storage unit 0215.

Next, the radio environment estimation device 0102 analyzes the radio environment at the estimation location between the sensors 0101. The following takes an example in which the radio environment estimation device 0102 analyzes the radio environment at the estimation location X in FIG. 1 from which it can look out over the radio base station 0103-1. The radio environment estimation device 0102 estimates the radio environment at the estimation location X, using IDW method and based on the observation amount of the nearby sensors 0101 including the sensor 0101-A. During this operation, the weighting coefficient with respect to the observation amount observed in each sensor 0101 takes a value that corresponds to the impact level of each sensor 0101 output from the weighting coefficient calculation unit 0216 as illustrated in FIG. 4 and FIG. 5. That is, the weighting coefficient with respect to the observation amount of the sensor 0101-A is calculated as a small value in accordance with the impact level, even when the observation location of the sensor 0101-A is near the estimation location. As a result, the impact that the observation amount of the sensor 0101-A will have on the estimation result of the radio environment is low.

### Explanation of Effect

According to the first example embodiment, the radio environment estimation device 0102 assesses the weighting coefficient of the weighted average with respect to the observation result of the sensor 0101 having a low impact level, to be a small value. By doing so, the effect of the sensor 0101 having a low impact level on the estimation result can be reduced. In addition, the radio environment estimation device 0102 performs assessment of the radio environment using Kriging method, one time as a prior assessment before the observation start, whereas it uses IDW method to estimate the radio environment at each location. Therefore, the radio environment estimation device 0102 can estimate a radio environment in a short period of time. Accordingly, the radio environment estimation device 0102 can perform estimation processing quickly, while suppressing the deterioration in estimation accuracy attributed to an impact of an obstacle existing near the sensor 0101.

### Second Example Embodiment

The following explains a second example embodiment according to the present invention with reference to the drawings.

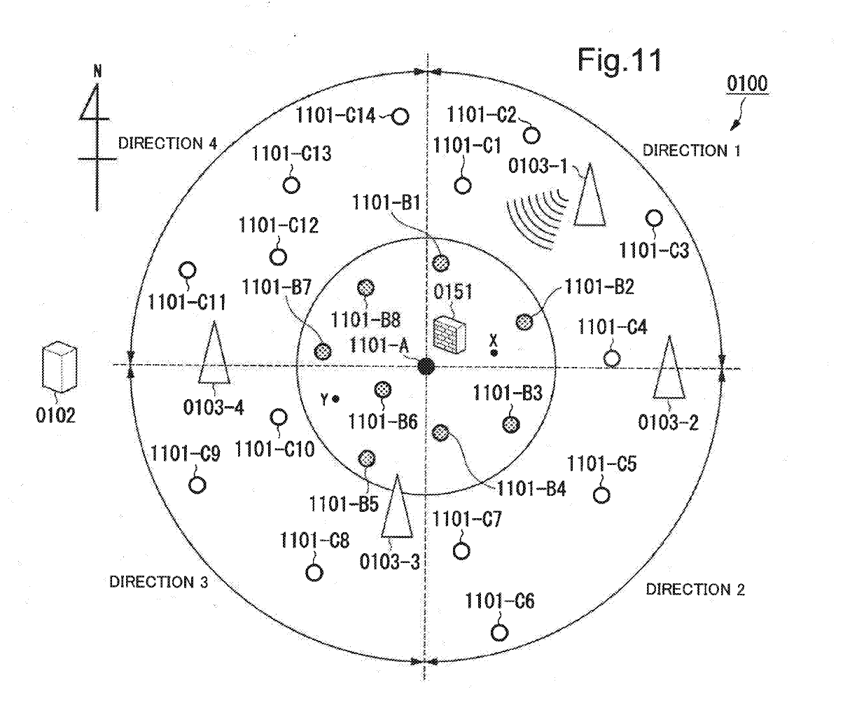

FIG. 11 illustrates an exemplary apparatus arrangement in a radio environment estimation system according to the second example embodiment.

A radio environment estimation system 0100 according to the second example embodiment includes an arrayed sensor 1101 instead of the sensor 0101 according to the first example embodiment. Here, the arrayed sensor 1101 is a sensor that can selectively receive radio wave in any direction. The radio environment estimation system 0100 according to the second example embodiment analyzes the radio environment in the observation area, based on the direction from which the radio wave arrives. Specifically, the radio environment estimation system 0100 calculates an impact level of the arrayed sensor 1101 for each direction (Directions 1 to 4), and estimates the radio environment at the estimation location, based on the impact level for each direction.

### Explanation of Configuration

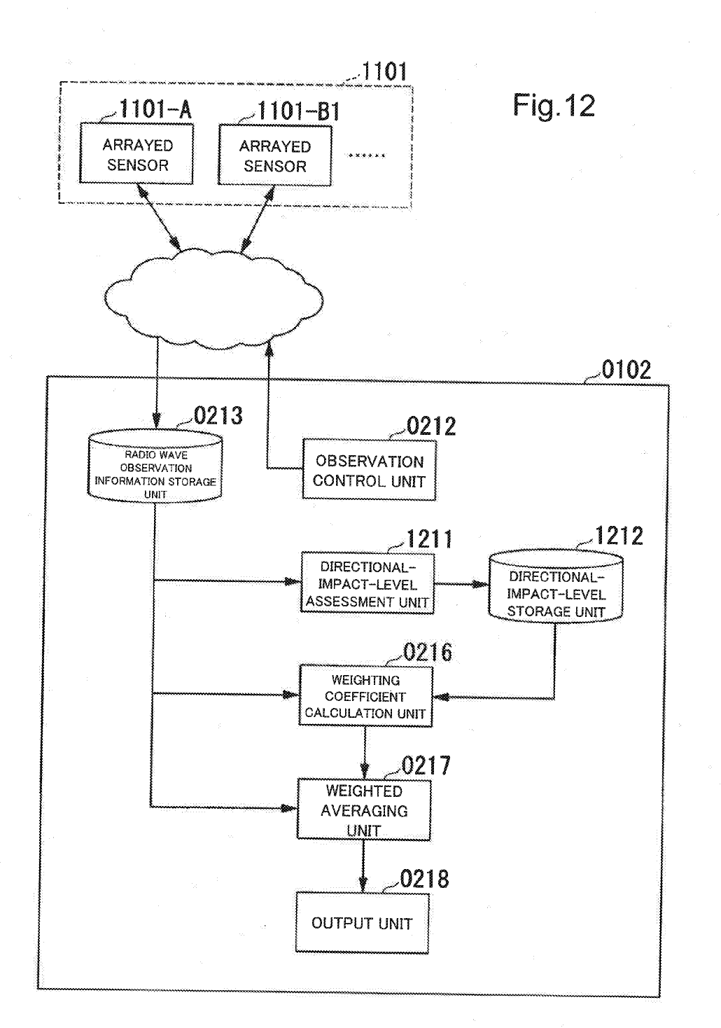

FIG. 12 illustrates a configuration of a radio environment estimation device according to the second example embodiment.

A radio environment estimation device 0102 according to the second example embodiment includes a directional-impact-level assessment unit 1211 and a directional-impact-level storage unit 1212, instead of the impact-level assessment unit 0214 and the impact-level storage unit 0215 according to the first example embodiment. The directional-impact-level assessment unit 1211 assesses the impact level of each arrayed sensor 1101 for each observed direction. The directional-impact-level storage unit 1212 stores therein impact levels in the observed directions, in association with the arrayed sensors 1101.

The following explains the first exemplary configuration and the second exemplary configuration, as exemplary configurations of the arrayed sensor 1101.

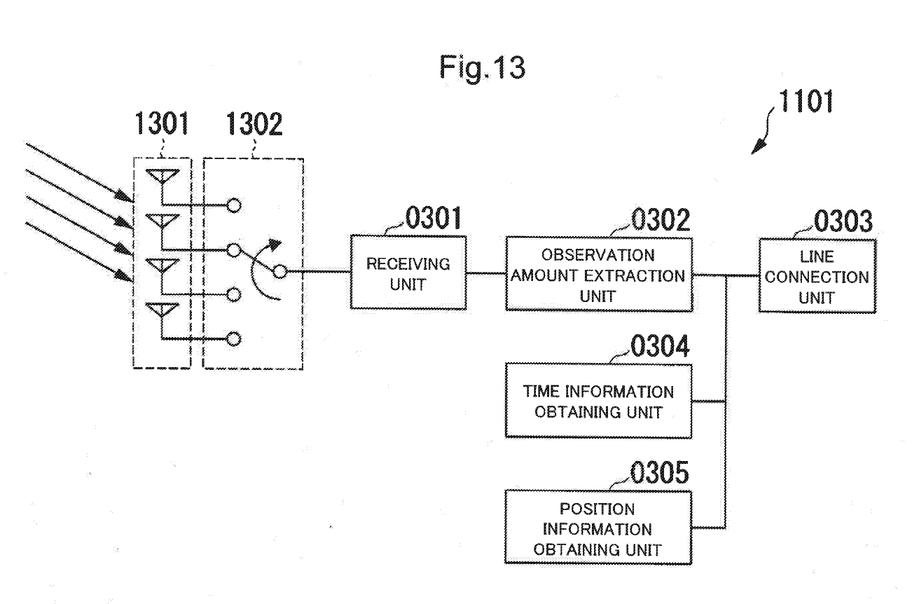

FIG. 13 illustrates the first exemplary configuration of the arrayed sensor according to the second example embodiment.

The arrayed sensor 1101 according to the first exemplary configuration includes a directivity antenna group 1301, an antenna switch 1302, a receiving unit 0301, an observation amount extraction unit 0302, a time information obtaining unit 0304, a position information obtaining unit 0305, and a line connection unit 0303.

Here, the directivity antenna group 1301, the antenna switch 1302, and the receiving unit 0301 are an example of a variable directivity receiver. The directivity antenna group 1301 is made up of a plurality of directivity antennas, each oriented towards a different direction from one another. Examples of the directivity antenna are a parabolic antenna and a patch antenna. The antenna switch 1302 switches between the directivity antennas to be connected to the receiving means, thereby determining which radio wave in which direction is to be selected. The antenna switch 1302 is controlled by the observation control unit 0212. As a result, the radio environment estimation device 0102 can obtain an impact level for a single arrayed sensor 1101, in accordance with the direction in which each directivity antenna is oriented.

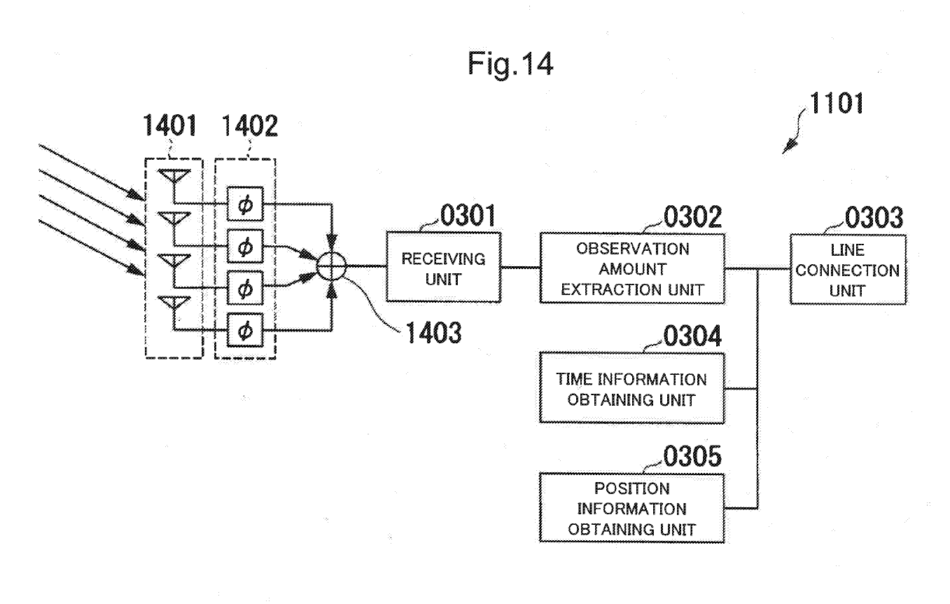

FIG. 14 illustrates a second exemplary configuration of the arrayed sensor according to the second example embodiment.

The arrayed sensor 1101 according to the second exemplary configuration includes an omnidirectional antenna group 1401, a phase shifter group 1402, an adder unit 1403, a receiving unit 0301, an observation amount extraction unit 0302, a time information obtaining unit 0304, a position information obtaining unit 0305, and a line connection unit 0303. The omnidirectional antenna group 1401, the phase shifter group 1402, the adder unit 1403, and the receiving unit 0301 are an example of the variable directivity receiver. An example of the omnidirectional antenna group 1401 is a dipole antenna. The radio wave received by each antenna in the omnidirectional antenna groups 1401 is phase-rotated by the phase shifter group 1402 in a respectively designated amount. Thereafter, the adder unit 1403 adds the respective radio waves, and outputs the result to the receiving unit 0301. Accordingly, only the radio waves from the designated direction will be emphasized, and the radio waves from the other directions will be offset. Therefore, the arrayed sensor 1101 can receive the radio wave solely in the designated direction. In addition, the direction of the wave to be received can be changed by the phase-shift amount shifted by each phase shifter constituting the phase shifter group 1402. Note that the phase-shift amount is controlled by the observation control unit 0212. As a result, the radio environment estimation device 0102 can obtain an impact level for a single arrayed sensor 1101 in accordance with the directivity.

Note that, in the above example, the arrayed sensor 1101 is used as a variable directivity receiver. However, in other example embodiments, another variable directivity receiver different from the arrayed sensor 1101 may be used. For example, a radio environment estimation system 0100 according to another example embodiment may include those variable directivity receivers that receive radio wave in any direction by mechanically rotating directivity antennas. In addition, a radio environment estimation system 0100 according to a still different example embodiment may include those variable directivity receivers that use Butler matrix including a plurality of input/output ports as an antenna, and cause, to be variable, the direction from which the received radio wave arrives, by switching the ports.

### Explanation of Operation

The following explains an operation in the second example embodiment, in detail. The operation in the second example embodiment is different from the operation in the first example embodiment, in the operation of prior assessment processing.

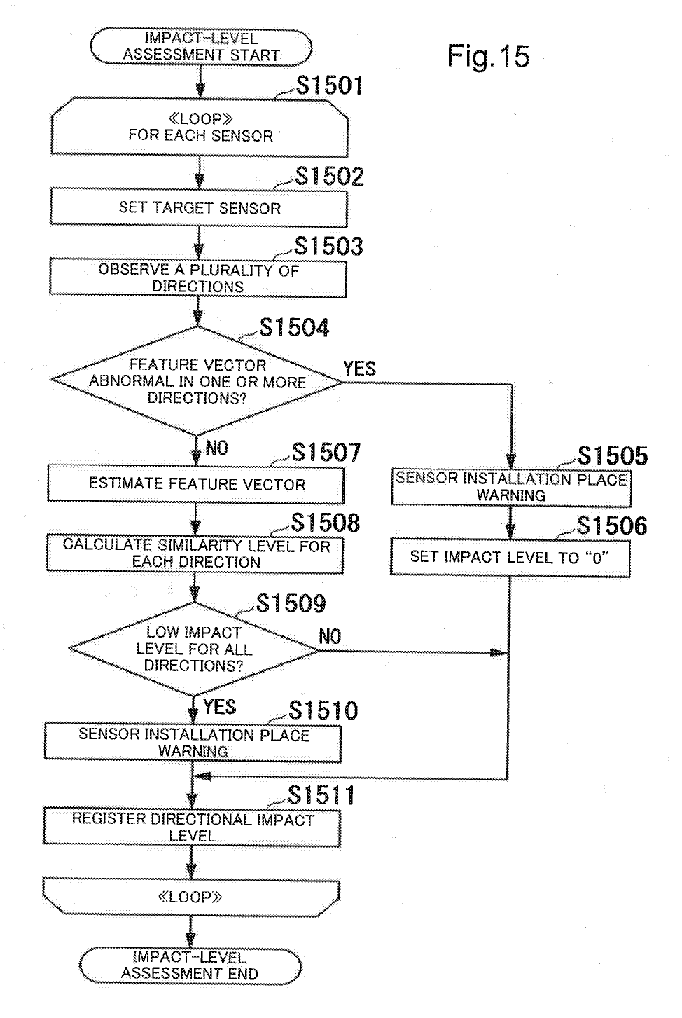

FIG. 15 is a flowchart illustrating prior assessment processing according to the second example embodiment.

When the radio environment estimation device 0102 starts prior assessment processing, the directional-impact-level assessment unit 1211 selects, one by one, target sensors which are to be a target whose impact level is to be assessed, from among the arrayed sensors 1101, and performs processing from Step S1502 to Step S1511 explained below (Step S1501).

The directional-impact-level assessment unit 1211 sets, for the target sensor selected in Step S1501 and the other sensors, a frequency to be observed, a gain or a bandwidth of receiving means, and the time for observation start (Step S1502). Next, the observation control unit 0212 causes the target sensor and the other sensors to observe a plurality of directions under the set conditions, and obtains the observation amount for the plurality of directions (Step S1503). During this process, it is preferable to control so that radio waves from the same radio base station 0103 can be received at the same time. Next, the directional-impact-level assessment unit 1211 judges whether the obtained observation amount has any abnormality (Step S1504). When there is an abnormality (Step S1504: YES), the directional-impact-level assessment unit 1211 issues a warning (Step S1505), and sets the impact level of that target sensor to the lowest value (Step S1506).

On the other hand, when there is no abnormality in the observation amount (Step S1504: NO), the directional-impact-level assessment unit 1211 estimates the observation amount for each direction, which is obtained by the target sensor, without using the result of the target sensor (Step S1507). Here, when estimating using the observation amount obtained in a nearby sensor, the directional-impact-level assessment unit 1211 decides from which direction each arrayed sensor 1101 receives the radio wave, based on the position from which the radio wave received by the target sensor is transmitted, i.e., based on the position of the radio base station 0103, and performs the estimation by using the observation amount obtained as a result of observation performed under the condition under which each arrayed sensor 1101 can receive that radio wave.

Next, the directional-impact-level assessment unit 1211 calculates, for each direction, a similarity level between the observation amount for each estimated direction and the observation amount for each direction actually obtained by the target sensor (Step S1508). Then, the directional-impact-level assessment unit 1211 judges whether the calculated similarity levels are smaller than a predetermined threshold value, for all the directions (Step S1509). When the similarity levels are smaller than the threshold value, for all the directions (Step S1509: YES), the target sensor is expected to be surrounded by obstacles, which is not a desirable situation. Therefore, the directional-impact-level assessment unit 1211 outputs a warning about sensor installation place (Step S1510).

When there is a direction in which the similarity level is either equal to or greater than the threshold value, (Step S1509: NO), or when a warning about sensor installation place has been output, the directional-impact-level assessment unit 1211 records, in the directional-impact-level storage unit 1212, the impact level for each obtained direction as the directional impact level of the target sensor, together with the sensor ID (Step S1511).

By performing the above processing to all the arrayed sensors 1101, the data on directional impact levels are accumulated in the directional-impact-level storage unit 1212.

The following specifically explains the operation in the second example embodiment, under the assumption of the environment illustrated in FIG. 11. Within the observation area illustrated in FIG. 11, arrayed sensors 1101-A, 1101-B1 to 1101-B8, arrayed sensors 1101-C1 to 1101-C14, and the radio base stations 0103-1 to 0103-4 are located. In addition, between the arrayed sensor 1101-A and the radio base station 0103-1, an obstacle 0151 is placed, and it is impossible to look out over the radio base station 0103-1 from the arrayed sensor 1101-A. In addition, the arrayed sensors 1101-B1 to 1101-B8 are located within a predetermined distance from the arrayed sensor 1101-A.

Note that, in this specific example, the northeast direction to the arrayed sensor 1101-A is referred to as Direction 1, the southeast direction is referred to as Direction 2, the southwest direction is referred to as Direction 3, and the northwest direction is referred to as Direction 4.

First, after setting the target arrayed sensor 1101-A and the other arrayed sensors 1101-B1 to 1101-B8 in a prior assessment step, the radio environment estimation device 0102 instructs observation, and obtains an observation amount. The observation amount observed in the target arrayed sensor 1101-A greatly differs from the observation amounts observed in the other arrayed sensors 1101-B1 to 1101-B8, especially in Direction 1, and the impact level is assessed to be low in Direction 1. On the other hand, there is no obstacle in Direction 2 to Direction 4. Therefore, the impact levels for Direction 2 to Direction 4 are assessed to be high. By performing such impact-level assessment to all the arrayed sensors 1101, the data on directional impact levels are accumulated in the directional-impact-level storage unit 1212.

Next, the radio environment estimation device 0102 analyzes the radio environment at the estimation locations between the arrayed sensors 1101. The following takes an example in which the radio environment estimation device 0102 analyzes the radio environments in the estimation location X and the estimation location Y in FIG. 11 from which the radio base station 0103-1 can be looked out over. When estimating the observation amount at the estimation location X, the radio environment estimation device 0102 adopts a directional impact level associated with the direction from each arrayed sensor 1101 towards the estimation location X, as the directional impact level of each arrayed sensor 1101. For example, the direction from the arrayed sensor 1101-A towards the estimation location X corresponds to Direction 1, and therefore, the radio environment is estimated by using the directional impact level for the arrayed sensor 1101-A which is associated with Direction 1. As a result, the weighting coefficient for the observation amount of the arrayed sensor 1101-A is calculated to be a small value, to correspond to the directional impact level, even though the observation location for the arrayed sensor 1101-A is near the estimation location. As a result, the effect that the observation amount of the arrayed sensor 1101-A has on the estimation result of the radio environment becomes small.

On the other hand, when estimating the observation amount at the estimation location Y, a directional impact level associated with Direction 3 is adopted, as the directional impact level of the arrayed sensor 1101-A. Because the directional impact level of the arrayed sensor 1101-A which is associated with Direction 3 is relatively high compared to the directional impact level associated with Direction 1, the radio environment is estimated based on a relatively large weighting coefficient.

### Explanation of Effect

According to the second example embodiment, the radio environment estimation device 0102 can perform estimation processing quickly, while suppressing the deterioration in estimation accuracy attributed to an impact of an obstacle existing near the arrayed sensor 1101, just as in the case of the first example embodiment.

Moreover, according to the second example embodiment, the radio environment estimation device 0102 can perform estimation on an arrayed sensor 1101 whose impact level is low in a part of the directions, by effectively using the observation result in the other directions.

### Third Example Embodiment

### Explanation of Configuration

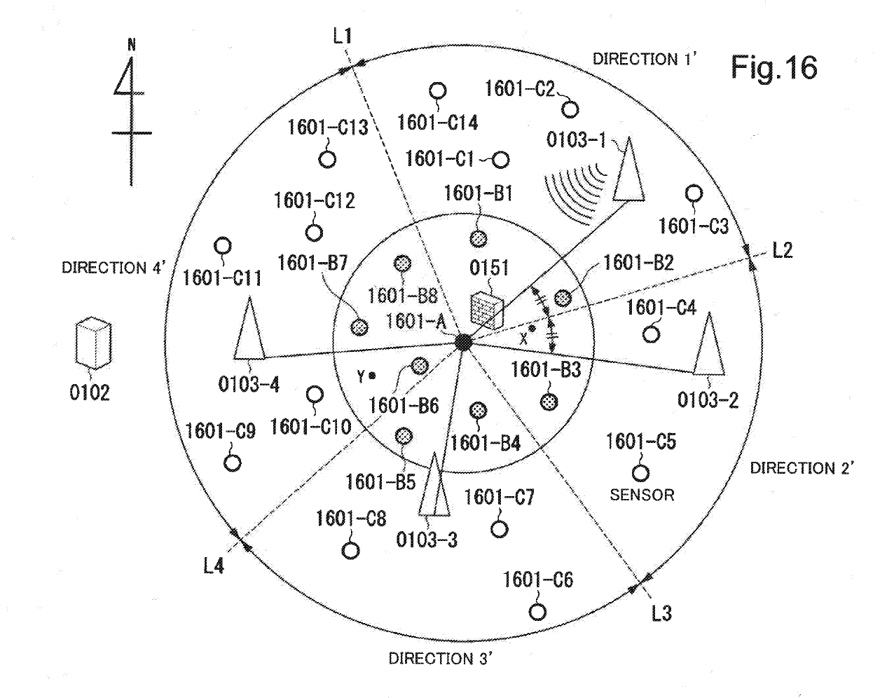

FIG. 16 illustrates an exemplary apparatus arrangement in a radio environment estimation system according to a third example embodiment.

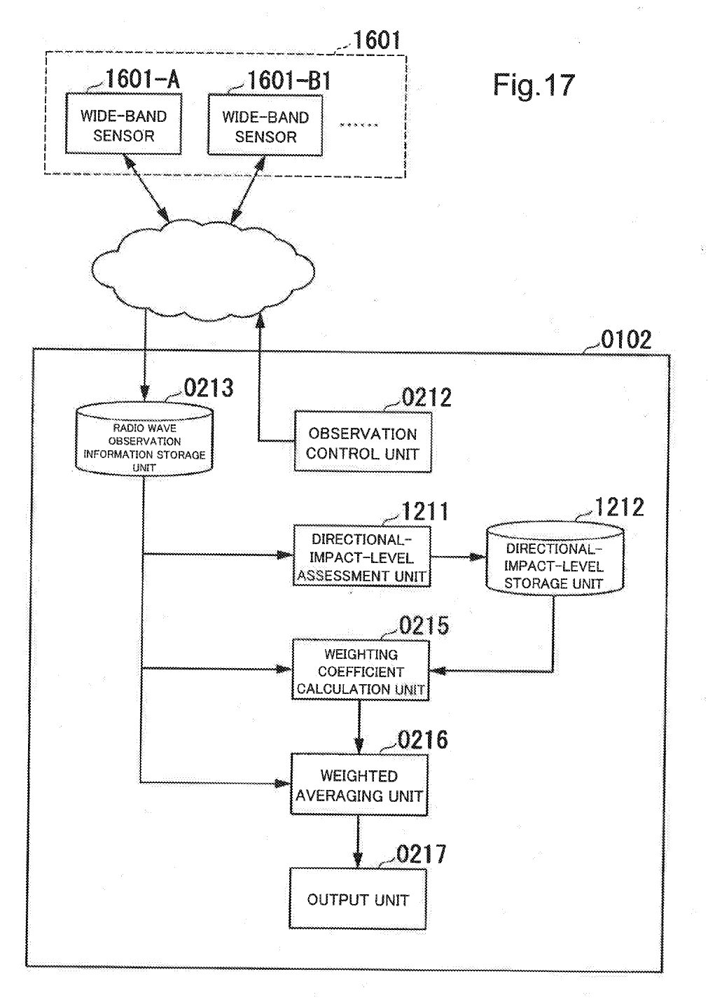

FIG. 17 illustrates a configuration of a radio environment estimation device according to the third example embodiment.

The radio environment estimation system 0100 according to the third example embodiment includes a wide-band sensor 1601 instead of the arrayed sensor 1101 according to the second example embodiment. The wide-band sensor 1601 is a sensor that can selectively receive radio waves in a plurality of frequency bands.

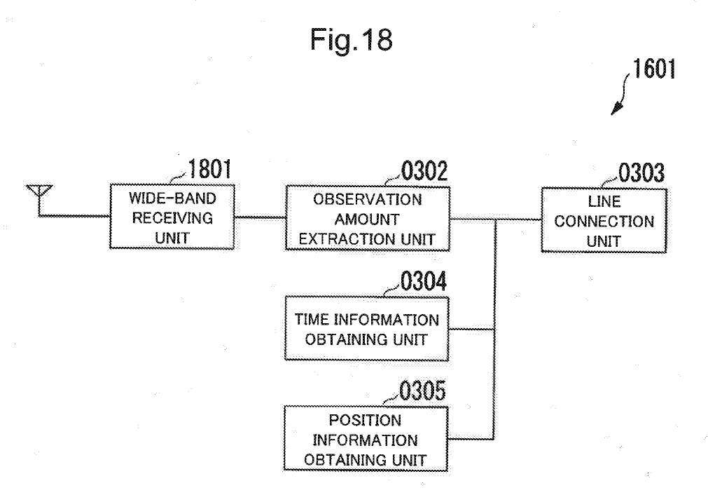

FIG. 18 illustrates an exemplary configuration of a wide-band sensor according to the third example embodiment.

The wide-band sensor 1601 includes a wide-band receiving unit 1801, an observation amount extraction unit 0302, a time information obtaining unit 0304, a position information obtaining unit 0305, and a line connection unit 0303. Here, the wide-band receiving unit 1801, together with the antenna, is an example of a wide-band receiver. The wide-band receiving unit 1801 selectively receives radio waves in a plurality of frequency bands. Note that the wide-band receiving unit 1801 does not always have to selectively receive radio wave in any direction, unlike the arrayed sensor 1101 according to the second example embodiment. Note that, in other example embodiments, the wide-band receiver may be constituted by a plurality of antennas and receiving means, which each is not wide-band.

### Explanation of Operation

The following explains an operation in the third example embodiment, in detail. The operation in the third example embodiment is different from the operation in the third example embodiment, in the operation of prior assessment processing.

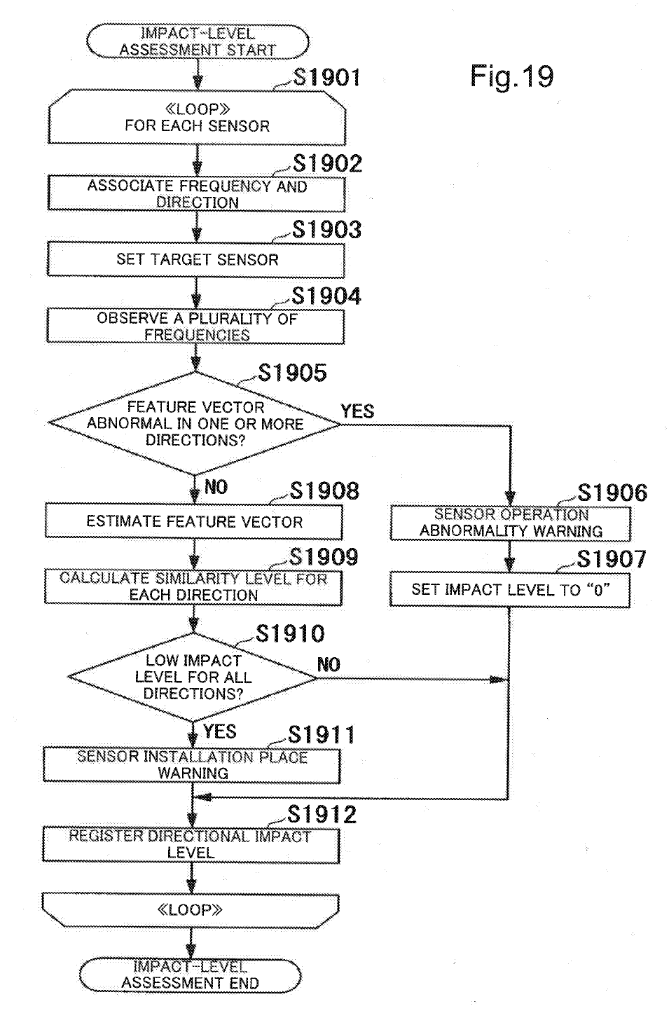

FIG. 19 is a flowchart illustrating prior assessment processing according to the third example embodiment.

When the radio environment estimation device 0102 starts prior assessment processing, the directional-impact-level assessment unit 1211 selects, one by one, target sensors which are to be a target whose impact level is to be assessed, from among the wide-band sensors 1601, and performs processing from Step S1902 to Step S1912 explained below (Step S1901).

The directional-impact-level assessment unit 1211 associates the observed frequencies and directions, by using the positional information of the wide-band sensor 1601 being an assessment target, and information on the position of the radio base station 0103 and the frequency of the transmission radio wave (S1902). Next, the directional-impact-level assessment unit 1211 sets, for the target sensor selected in Step S1901 and the other sensors, a frequency to be observed, a gain or a bandwidth of receiving means, and the time for observation start (Step S1903). Next, the observation control unit 0212 causes the target sensor and the other sensors to observe a plurality of frequencies under the set conditions, and obtains the observation amount for the plurality of directions (Step S1904). During this process, the observation amount for each frequency is interpreted as an observation amount for each direction. Next, the directional-impact-level assessment unit 1211 judges whether the obtained observation amount has any abnormality (Step S1905). When there is an abnormality (Step S1905: YES), the directional-impact-level assessment unit 1211 issues a warning (Step S1906), and sets the impact level of that target sensor to the lowest value (Step S1907).

On the other hand, when there is no abnormality in the observation amount (Step S1905: NO), the directional-impact-level assessment unit 1211 estimates the observation amount for each direction, which is obtained by the target sensor, without using the result of the target sensor (Step S1908). Next, the directional-impact-level assessment unit 1211 calculates, for each direction, a similarity level between the observation amount for each estimated direction and the observation amount for each direction actually obtained by the target sensor (Step S1909). Then, the directional-impact-level assessment unit 1211 judges whether the calculated similarity levels are smaller than a predetermined threshold value, for all the directions (Step S1910). When the similarity levels are smaller than the threshold value, for all the directions (Step S1910: YES), the target sensor is expected to be surrounded by obstacles, which is not a desirable situation. Therefore, the directional-impact-level assessment unit 1211 outputs a warning about sensor installation place (Step S1911).

When there is a direction in which the similarity level is either equal to or greater than the threshold value, (Step S1910: NO), or when a warning about sensor installation place has been output, the directional-impact-level assessment unit 1211 records, in the directional-impact-level storage unit 1212, the impact level for each obtained direction as the directional impact level of the target sensor, together with the sensor ID (Step S1912).

By performing the above processing to all the wide-band sensors 1601, the data on directional impact levels are accumulated in the directional-impact-level storage unit 1212.

The following specifically explains the operation in the third example embodiment, under the assumption of the environment illustrated in FIG. 16. Within the observation area illustrated in FIG. 16, wide-band sensors 1601-A, 1601-B1 to 1601-B8, wide-band sensors 1601-C1 to 1601-C14, and radio base stations 0103-1 to 0103-4 are located. In addition, between the wide-band sensor 1601-A and the radio base station 0103-1, an obstacle 0151 is placed, and it is impossible to look out over the radio base station 0103-1 from the wide-band sensor 1601-A. In addition, the wide-band sensors 1601-B1 to 1601-B8 are located within a predetermined distance from the wide-band sensor 1601-A.

Note that FIG. 16 illustrates four bisectors L1 to L4. The bisector L1 is a bisector of an angle formed between a line connecting the wide-band sensor 1601-A and the radio base station 0103-4 and a line connecting the wide-band sensor 1601-A and the radio base station 0103-1. The bisector L2 is a bisector of an angle formed between a line connecting the wide-band sensor 1601-A and the radio base station 0103-1 and a line connecting the wide-band sensor 1601-A and the radio base station 0103-2. The bisector L3 is a bisector of an angle formed between a line connecting the wide-band sensor 1601-A and the radio base station 0103-2 and a line connecting the wide-band sensor 1601-A and the radio base station 0103-3. The bisector L4 is a bisector of an angle formed between a line connecting the wide-band sensor 1601-A and the radio base station 0103-3 and a line connecting the wide-band sensor 1601-A and the radio base station 0103-4.

Here, the direction including the range from the direction in which the bisector L1 extends to the direction in which the bisector L2 extends is referred to as “Direction 1′”. The direction including the range from the direction in which the bisector L2 extends to the direction in which the bisector L3 extends is referred to as “Direction 2′”. The direction including the range from the direction in which the bisector L3 extends to the direction in which the bisector L4 extends is referred to as “Direction 3′”. The direction including the range from the direction in which the bisector L4 extends to the direction in which the bisector L1 extends is referred to as “Direction 4′”. Note that each direction is determined by a relative position between each wide-band sensor 1601 and each radio base station 0103. Therefore, the above explanation only applies to the wide-band sensor 1601-A. In addition, the frequency of the transmission radio wave of the radio base station 0103-1 is fA, the frequency of the transmission radio wave of the radio base station 0103-2 is fB, the frequency of the transmission radio wave of the radio base station 0103-3 is fC, and the frequency of the transmission radio wave of the radio base station 0103-4 is fD.

First, after setting the target wide-band sensor 1601-A and the other wide-band sensors 1601-B1 to 1601-B8 in a prior assessment step, the radio environment estimation device 0102 instructs observation, and obtains an observation amount. In assessing the directional impact level of the wide-band sensor 1601-A, the radio environment estimation device 0102 observes each of the frequencies fA, fB, fC, and fD. The observation amount of the radio wave of the frequency fA is associated with the Direction 1′.

The observation amount of the radio wave of the frequency fB is associated with the Direction 2′. The observation amount of the radio wave of the frequency fC is associated with the Direction 3′. The observation amount of the radio wave of the frequency fD is associated with the Direction 4′. The observation amount observed in the wide-band sensor 1601-A as a result of the observation greatly differs from the observation amount observed in the other wide-band sensors 1601-B1 to 1601-B8, especially for the frequency fA. Therefore, the impact level concerning Direction 1′ of the wide-band sensor 1601-A is assessed to be low. On the other hand, there is no obstacle in Direction 2′ to Direction 4′. Therefore, the impact levels for Direction 2′ to Direction 4′ are assessed to be high. By performing such impact-level assessment to all the wide-band sensors 1601, the data on directional impact levels are accumulated in the directional-impact-level storage unit 1212.

Next, the radio environment estimation device 0102 analyzes the radio environment at the estimation locations between the wide-band sensors 1601. The following takes an example in which the radio environment estimation device 0102 analyzes the radio environments in the estimation location X and the estimation location Y in FIG. 1 from which the radio base station 0103-1 can be looked out over. When estimating the observation amount at the estimation location X, the radio environment estimation device 0102 adopts a directional impact level associated with the direction from each wide-band sensor 1601 towards the estimation location X, as the directional impact level of each wide-band sensor 1601. For example, the direction from the wide-band sensor 1601-A towards the estimation location X corresponds to Direction 1′, and therefore, the radio environment is estimated by using the directional impact level for the wide-band sensor 1601-A which is associated with Direction 1′. As a result, the weighting coefficient for the observation amount of the wide-band sensor 1601-A is calculated to be a small value, to correspond to the directional impact level, even though the observation location for the wide-band sensor 1601-A is near the estimation location. As a result, the effect that the observation amount of the wide-band sensor 1601-A has on the estimation result of the radio environment becomes small.

On the other hand, when estimating the observation amount at the estimation location Y, a directional impact level associated with Direction 4′ is adopted, as the directional impact level of the wide-band sensor 1601-A. Because the directional impact level of the wide-band sensor 1601-A which is associated with Direction 4′ is relatively high compared to the directional impact level associated with Direction 1, the radio environment is estimated based on a relatively large weighting coefficient.

### Explanation of Effect

The following explains effects of the present example embodiment.

According to the third example embodiment, the radio environment estimation device 0102 can perform estimation processing quickly, while suppressing the deterioration in estimation accuracy attributed to an impact of an obstacle existing near the wide-band sensor 1601, just as in the case of the first example embodiment.

Moreover, according to the third example embodiment, the radio environment estimation device 0102 can perform estimation on a wide-band sensor 1601 whose impact level is low in a part of the directions, by effectively using the observation result in the other directions, just as in the case of the second example embodiment. In addition, because the configuration of the wide-band sensor 1601 is simpler than that of the arrayed sensor 1101 according to the second example embodiment, the third example embodiment can reduce the size and cost of the sensors, compared to the second example embodiment.

So far, detailed explanation has been made to an example embodiment with reference to the drawings. However, the specific configuration is not limited to as described above, and varieties of changes can be made thereto.

### Basic Configuration

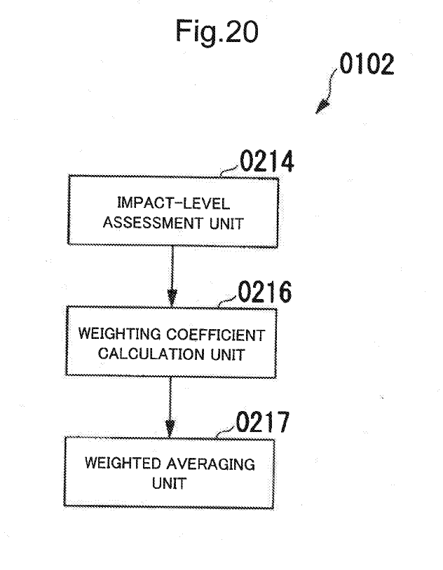

FIG. 20 illustrates a basic configuration of a radio environment estimation device.

While some example embodiments of the radio environment estimation device 0102 are explained in the above-explained example embodiments, the basic configuration of the radio environment estimation device 0102 is as illustrated in FIG. 20.

That is, the basic configuration of the radio environment estimation device 0102 is an impact-level assessment unit 0214, a weighting coefficient calculation unit 0216, and a weighted averaging unit 0217.

The impact-level assessment unit 0214 assesses the impact level that represents a level of impact that the observation amount detected by a sensor for detecting an observation amount representing a feature of an electric signal obtained by receiving radio wave has on an observation amount at other locations.

The weighting coefficient calculation unit 0216 calculates a weighting coefficient of a sensor, based on the position of the estimation location to be an observation-amount estimation target and the position of the sensor, as well as on the impact level assessed by the impact-level assessment unit 0214.

The weighted averaging unit 0217 estimates the observation amount at the estimation location, by calculating the weighted average of the observation amount detected by a sensor, using the weighting coefficient of the sensor having been calculated by the weighting coefficient calculation unit 0216.

Note that the above-explained radio environment estimation device 0102 is implemented in a computer. The above-explained operations of each processing unit are stored in an auxiliary storage in a program format. A CPU reads the program from the auxiliary storage, expands the program on the main memory, and executes the above-explained processing in accordance with the program. In addition, the CPU secures a storage space for each storage described above in accordance with the program, in the main memory.

Note that, in at least one example embodiment, the auxiliary storage is an example of a non-transitory tangible medium. Other examples of such a non-transitory tangible medium include magnetic disk, magneto-optical disk, compact disc read only memory (CD-ROM), digital versatile disc read only memory (DVD-ROM), and semiconductor memory, which are connected via an interface. When this program is distributed to a computer via a communication line, the computer having received the distribution may expand the program on the main memory, and execute the above-explained processing.

In addition, the program may realize a part of the above-explained functions.

Furthermore, the program may be a so-called difference file (difference program), which realizes the above-explained functions, in cooperation with the other programs already stored in the auxiliary storage.

The present application claims a priority based on Japanese Patent Application No. 2016-011695 filed on Jan. 25, 2016, the entire disclosure of which is incorporated herein.

### REFERENCE SIGNS LIST

0100 Radio environment estimation system

0101 Sensor

0102 Radio environment estimation device

0212 Observation control unit

0213 Radio wave observation information storage unit

0214 Impact-level assessment unit

0215 Impact-level storage unit

0216 Weighting coefficient calculation unit

0217 Weighted averaging unit

0218 Output unit

1. A radio environment estimation device comprising:
impact-level assessment means for assessing an impact level that represents a level of impact that an observation amount representing a feature of an electric signal obtained by receiving a radio wave and that is detected by a sensor for detecting the observation amount has on an observation amount at other locations;
weighting coefficient calculation means for calculating a weighting coefficient of the sensor, based on a position of an estimation location to be an observation-amount estimation target and a position of the sensor, as well as on the impact level assessed by the impact-level assessment unit; and
weighted averaging means for estimating an observation amount at the estimation location, by calculating a weighted average of the observation amount detected by the sensor, using the weighting coefficient of the sensor having been calculated by the weighting coefficient calculation means.

2. The radio environment estimation device according to claim 1, wherein
the impact-level assessment means assesses the impact level in accordance with a direction from which the radio wave received by the sensor arrives.

3. The radio environment estimation device according to claim 2, wherein
the sensor includes a variable directivity receiver that can receive the radio wave by selectively switching a reception direction, and
the observation amount includes information on the direction.

4. The radio environment estimation device according to any one of claims 1 to 3, wherein
the sensor includes a wide-band receiver that can selectively receive a radio wave of any frequency band, and
the impact-level assessment means assesses the impact level for each frequency band of the sensor.

5. The radio environment estimation device according to any one of claims 1 to 4, further comprising:
observation amount estimation means for calculating an estimated observation amount that is an estimated value of an observation amount detected by a target sensor being the sensor to be an impact-level assessment target; and
similarity level calculation means for calculating a similarity level between the estimated observation amount and the observation amount detected by the target sensor, wherein
the impact-level assessment means assesses the impact level, based on the similarity level calculated by the similarity level calculation means.

6. The radio environment estimation device according to claim 5, wherein
the observation amount estimation means calculates the estimated observation amount of the target sensor, based on an observation amount of other sensors.

7. The radio environment estimation device according to claim 5 or 6, wherein
the observation amount estimation means calculates the estimated observation amount, based on information including a position and a modulation method of a base station being a transmitter of a radio wave received by the sensor.

8. A radio environment estimation system comprising:
a sensor for detecting an observation amount representing a feature of an electric signal obtained by receiving a radio wave; and
the radio environment estimation device according to any one of claims 1 to 7.

9. A radio environment estimation method comprising:
assessing an impact level that represents a level of impact that an observation amount representing a feature of an electric signal obtained by receiving a radio wave and that is detected by a sensor for detecting the observation amount has on an observation amount at other locations;
calculating a weighting coefficient of the sensor, based on a position of an estimation location to be an observation-amount estimation target and a position of the sensor, as well as on the assessed impact level; and
estimating an observation amount at the estimation location, by calculating a weighted average of the observation amount detected by the sensor, using the weighting coefficient of the sensor having been calculated.

10. A recording medium storing therein a program to make a computer to execute:
assessing an impact level that represents a level of impact that an observation amount representing a feature of an electric signal obtained by receiving a radio wave and that is detected by a sensor for detecting the observation amount has on an observation amount at other locations;
calculating a weighting coefficient of the sensor, based on a position of an estimation location to be an observation-amount estimation target and a position of the sensor, as well as on the assessed impact level; and
estimating an observation amount at the estimation location, by calculating a weighted average of the observation amount detected by the sensor, using the weighting coefficient of the sensor having been calculated.
